(19) United States
(12) Patent Application Publication
(10) Pub. No.: US 2008/0317459 A1
(43) Pub. Date: Dec. 25, 2008

(54) Electrical Aperture and Shutter Device having a transparence Switching Element

(76) Inventors: Wei Chen Chih, Hukou Township (TW); Wen Chia Chang, Jhubei City (TW)

Correspondence Address: HDSL, P.O. BOX 220746, CHANTILLY, VA, 20153-0746, US

(21) Appl. No.: 11/767,491

(22) Filed: Jun. 23, 2007

(51) Int. Cl. G02F 1/03; G02B 26/02

(52) U.S. Cl. 396/457; 359/227

(57) ABSTRACT

An electrical aperture and shutter device having a transparence switching element includes an operating element, a transparence switching element, and a controller. The operating element is configured for producing a signal. The transparence switching element is configured for controlling a transparence and a light-passing time of the transparence switching element and thereby carrying out the functions of aperture and shutter. The controller is configured for controlling an operation of the transparence switching element by receiving the signal produced by the operating element. A camera incorporated an electrical aperture and shutter device having a transparence switching element therein, also is provided.

### BACKGROUND

1. Technical Field

The present invention relates generally to an aperture and shutter device, and more particularly, to an electrical aperture and shutter device.

2. Description of the Related Art

Still or video cameras are very popular image capture devices in people's daily life. In photography technologies, light exposure is defined as an amount of light incident on a film or a digital image sensor. A light exposure control device used in cameras generally includes two parts: one is an aperture and the other one is a shutter. The aperture is configured for controlling a size of lens opening so as to control a size of light incident area. The shutter is configured for taking the charge of controlling an opening time of the aperture so as to control the exposure time. For some simple cameras, an aperture thereof is fixed and thereby could not be adjusted by the user. In the past, for most of cameras, the aperture and shutter speed must be manually adjusted via the user; but in recent years, most of manufactured cameras are equipped with automatic apertures or shutters.

Conventional aperture and shutter devices used in still or video cameras usually are the combinations of mechanical apertures and shutters. These mechanical aperture and shutter devices generally each includes a front barrel, an aperture, a shutter, and a rear barrel. Wherein, the aperture is consisted of a movable light-blocking sheet and a light-blocking sheet driver. The light-blocking sheet driver is used for controlling an opening size defined by the light-blocking sheet, so as to reach the purpose of controlling the aperture size. The shutter is consisted of a shutter disc and a shutter driver. The shutter driver is used for control an operation of the shutter disc. However, the above-mentioned aperture and shutter devices have the disadvantages of excessive parts and complex assembly, which render the aperture and shutter devices unduly bulky and awkward and hence would not meet the miniaturization requirement of digital cameras or mobile phone cameras, in some extent.

### BRIEF SUMMARY

The present invention is to provide a compact electrical aperture and shutter device having a transparence switching element.

Another, the present invention is to provide a compact camera in which an electrical aperture and shutter device having a transparence switching element is incorporated.

The present invention provides an electrical aperture and shutter device having a transparence switching element, in associated with a preferred embodiment of the present invention, includes an operating element, an optical sensor, a transparence switching element, and a controller. The transparence switching element is configured (i.e., structured and arranged) for controlling a transparence and a light-passing time (i.e., generally a maintain time of light being allowed to pass through) of the transparence switching element, and thereby carrying out the functions of aperture and shutter. The controller is configured for controlling an operation of the transparence switching element, based upon a light amount sensed by the optical sensor and/or a signal from the operating element.

In another preferred embodiment, at the time of the transparence switching element being operated to allow light to pass therethrough, the transparence switching element acts as an aperture and is used to control an amount of passed light, i.e., a total transparence of the transparence switching element.

In another further preferred embodiment, at the time of the transparence switching element being operated to allow light to pass therethrough or not, the transparence switching element acts as a shutter and is used to control a light-passing time at a certain transparence.

In a yet another further preferred embodiment, the transparence switching element is a liquid crystal panel.

A camera, in associated with a preferred embodiment of the present invention, includes a lens, an imaging device, and an electrical aperture and shutter device having a transparence switching element. The electrical aperture and shutter device is configured for controlling an imaging light from the lens for imaging in the imaging device. The electrical aperture-shutter device includes an operating element, an optical sensor, a transparence switching element, and a controller. The transparence switching element is configured for controlling a transparence and a light-passing time of the transparence switching element, and thereby carrying out the functions of aperture and shutter. The controller is configured for controlling an operation of the transparence switching element, based upon a light amount sensed by the optical sensor and/or a signal from the operating element.

The present electrical aperture and shutter device utilizes a transparence switching element (e.g., a liquid crystal panel), by way of a control of an external electric field, the transparence switching element would produce variations of transparence. Based upon the variations of transparence, an exposure time and an amount of passed light can be controlled and thereby the functions of aperture and shutter functions are achieved. The present electrical aperture and shutter device avoids the disadvantage of excessive parts of the conventional mechanical aperture and shutter devices, so that a camera would be more readily miniaturizable, besides a volume of lens could be reduced. Furthermore, the present electrical aperture and shutter device makes use of a total transparence of the transparence switching element, i.e., an intensity of passed light to control an amount of passed light, and therefore becomes more easily operable.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a schematic functional block diagram of an electrical aperture and shutter device, in associated with a preferred embodiment of the present invention, the electrical aperture and shutter device including a transparence switching element.

FIG. 2 is a schematic structure of a transparence switching element, in associated with the preferred embodiment of the present invention.

FIG. 3 is a schematic and planar view of a bottom glass substrate of a transparence switching element, in associated with the preferred embodiment of the present invention.

### DETAILED DESCRIPTION

The present invention utilizes a transparence switching element which for example is made of a liquid crystal material or other special materials having similar characteristics to the liquid crystal material, under a control of an electric field, the transparence switching element switchably produce various transparences, such as transparent, partial light-transmissible, or opaque. Based upon the production of various transparences, an exposure time and an amount of passed light are controllable and therefore the functions of aperture and shutter are carried out.

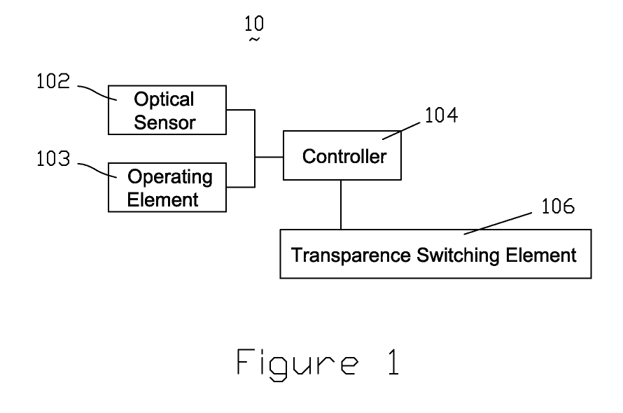

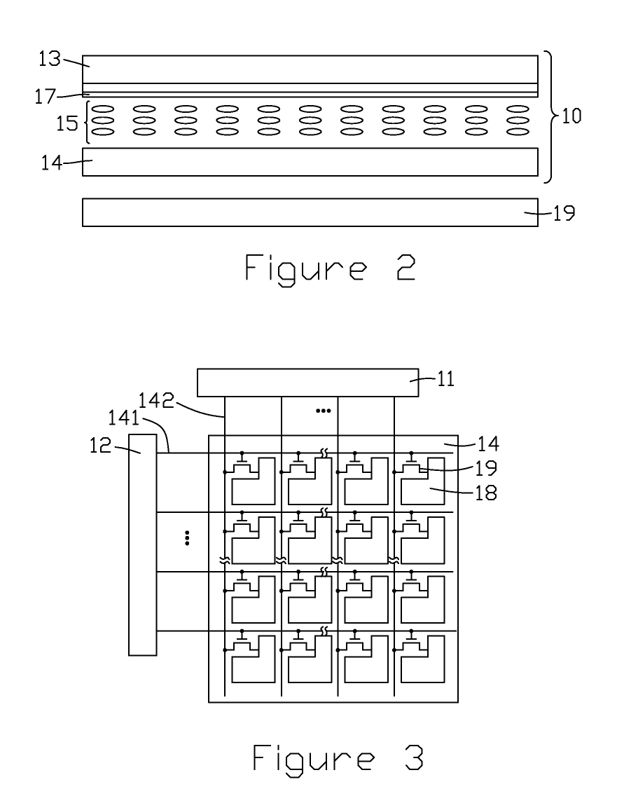

Referring to FIG. 1, a schematic functional block diagram of an electrical aperture and shutter device 10, in associated with a preferred embodiment of the present invention, is provided. The electrical aperture and shutter device 10 includes an optical sensor 102, an operating element 103, a controller 104, and a transparence switching element 106. The operating element 103 is configured (i.e., structured and arranged) for sending a signal to the controller 104 so as to operate the electrical aperture and shutter device 10. The operating element 103 generally includes, for example, a shutter button (not shown) and/or an aperture and shutter setting button (not shown), etc, a user can control an operation of the electrical aperture and shutter device 10 based on such buttons. The optical sensor 102 is configured for measuring and calculating an amount of light entering into a lens, and thus sending a light-amount signal representative of a calculated out result to the controller 104. The controller 104 determines an exposure time and an exposure quantity based upon the light-amount signal from the optical sensor 102 and/or another signal from the operating element 103, calculates out an intensity and a maintain time of an electric field will be applied to the transparence switching element 106, and thus applies the calculated out electric field to the transparence switching element 106 in response to the signal from the operating element 103. As a result, the electrical aperture and shutter device 10 would adjust an amount of passed light and a light-passing time of the transparence switching element 106 corresponding to an optimal shutter time and an optimal amount of light required for imaging, so as to control an imaging light entering into a lens to incident in an imaging area with a desired manner.

The transparence switching element 106 suitably is made of a liquid crystal material or other special materials with similar characteristics to the liquid crystal material. Under a control of an electric field, the transparence switching element 106 would selectably produce a transparent state, a partial light-transmissible state, or an opaque state. In the illustrated embodiment, the transparence switching element is made of a liquid crystal material, and thus can be a liquid crystal panel correspondingly. The liquid crystal panel 106 includes a top glass substrate 13, a bottom glass substrate 14 disposed opposite to the top glass substrate 13, a liquid crystal layer 15 interposed between the top and the bottom glass substrates 13, 14.

The top glass substrate 13 defines a bottom surface adjacent to the liquid crystal layer 15, and a common electrode 17 is formed on the bottom surface. The common electrode 17 advantageously is made from an indium tin oxide (ITO), and would be shared for the entire liquid crystal panel 106.

Referring to FIG. 3, shows a schematic and planar structure of the bottom glass substrate 14 of the liquid crystal panel 16. The bottom glass substrate 14 defines a top surface adjacent the liquid crystal layer 15; a plurality of parallel scanning lines 141, a plurality of data lines 142 substantially orthogonal to the scanning lines 41, and a plurality of pixel electrodes 18 all are formed on the top surface. The data lines 142 are configured to supply a gray scale voltage for corresponding pixel electrodes 18. The liquid crystal panel 106 also includes a plurality of pixels (not labeled) arranged in a matrix array, and each pixel includes a pixel electrode 18 and a switching element 19. The pixel electrode 18 is matched with the common electrode 17, and liquid crystal molecules are interposed between the pixel electrode 18 and the common electrode 17. The switching element 19 is configured for controlling the time of an electric field applied to a corresponding pixel. The switching element 19 can be, for example a metal-oxide semiconductor (MOS) switching element.

A scan driver circuit 12 and data driver circuit 11 are disposed at two adjacent edges of the top surface of the bottom glass substrate 14. The scan driver circuit 12 is electrically coupled to the plurality of scanning lines 141 and is used for supplying a scanning signal thereto. The data driver circuit 11 is electrically coupled to the plurality of data lines 142 and is used for supplying a gray scale signal thereto.

In an operation of the electrical aperture and shutter device 10, the controller 104 determines an exposure time and an exposure quantity based upon a light-amount signal from the optical sensor 102 and/or another signal from the operating element 103, calculates out an intensity and a maintain time of an electric field will be applied to the transparence switching element 106, and then issues a control signal to the scan driver circuit 12 and the data driver circuit 11 of the transparence switching element 106 (i.e., the liquid crystal panel 106). The scan driver circuit 12 and the data driver circuit 11 cooperatively apply gray scale voltages to corresponding pixel electrodes 18 under the control of the control signal. The common electrode 17 is applied a common voltage thereto. Liquid crystal molecules interposed between a pixel electrode 18 and the common electrode 17 corresponding to each of the pixels are twisted with a certain angle under an effect of an electric field derived from a voltage difference formed between the pixel electrode 18 and the common electrode 17, in order to control an amount of passed light and a light-passing time, and therefore the liquid crystal panel 106 achieves the functions of aperture and shutter. At the time of the liquid crystal panel 106 being operated to allow light to pass therethrough, the liquid crystal panel 106 acts as an aperture. In this case, the liquid crystal molecules, under the effect of different electric fields, would realize different orientations so as to control the amount of passed light, and therefore the control of the aperture size can be achieved. At the time of the liquid crystal panel 106 being operated to completely block the light, the light-passing time under the control of the liquid crystal panel 106 acts the role of a shutter time. By way of instant stopping exposure via the completely light blocking, the purpose of controlling the light-passing time can be achieved.

The above embodiments are given only for exemplary purpose, in the technical implementations of the present invention, it is unessential to be equipped with the plurality of pixel electrodes 18. The number of the pixel electrodes 18 should be determined by practical requirements, for example, the electrical aperture and shutter device 10 can be only equipped with one pixel electrode 18 which almost covers the entirety of the top surface, but the liquid crystal panel also can achieve the functions of aperture and shutter by way of directly controlling an amount of passed light and a light-passing time of the pixel electrode 18. Of course, the electrical aperture and shutter device 10 also can be equipped with a plurality of pixel electrodes 18, similar to that shown in FIG. 3; in this case, an aperture value of the liquid crystal panel can be designed to achieve a predetermined level, or each of the pixel electrodes can be configured with a same or different aperture value. In addition, the plurality of pixel electrodes 18 are not limited to be arranged in the matrix array, they also can be arranged in other different modes according to practical requirements, for example, in a circular mode.

In sum, the present electrical aperture and shutter device 10 makes use of a transparence switching element 106, e.g., a liquid crystal panel, by way of a control of an external electric field, the transparence switching element 106 would produce variations of transparence. Based upon the variations of transparence, an exposure time and an amount of passed light can be controlled and thereby the functions of aperture and shutter are achieved. The present electrical aperture and shutter device 10 avoids the disadvantage of excessive parts of the conventional mechanical aperture and shutter devices, so that a camera would be more readily miniaturizable, besides a volume of lens could be reduced. Furthermore, the present electrical aperture and shutter device utilizes a total transparence of the transparence switching element 106, i.e., an intensity of passed light, to control an amount of passed light, and therefore becomes more easily operable.

A camera including an electrical aperture and shutter device having a transparence switching element, in associated with a preferred embodiment of the present invention, also is provided. The camera includes a lens, an aperture and shutter device, and an imaging device. The aperture and shutter device suitably is the above-mentioned electrical aperture and shutter device 10 having a transparence switching element. In an operation of the camera, an imaging light enters into the lens, by way of controlling a transparence of the electrical aperture and shutter device 10, the imaging light could incident in the imaging device in an optimal state.

The above description is given by way of example, and not limitation. Given the above disclosure, one skilled in the art could devise variations that are within the scope and spirit of the invention disclosed herein, including configurations ways of the recessed portions and materials and/or designs of the attaching structures. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. An electrical aperture and shutter device, comprising:
an operating element configured for producing a signal;
an transparence switching element configured for controlling a transparence and a light-passing time of the transparence switching element and thereby achieving functions of aperture and shutter; and
a controller configured for controlling an operation of the transparence switching element by receiving the signal produced by the operating element.

2. The electrical aperture and shutter device according to claim 1, wherein at time of the transparence switching element being operated to allow light to pass therethrough, the transparence switching element acts as an aperture and is configured for controlling an amount of passed light which is a total transparence of the transparence switching element.

3. The electrical aperture and shutter device according to claim 1, wherein at time of the transparence switching element being operated to allow light to pass therethrough or not, the transparence acts a shutter and is configured for controlling a light-passing time at a certain transparence.

4. The electrical aperture and shutter device according to claim 1, further comprising an optical sensor, the optical sensor being electrically connected with the controller, and the controller being configured for controlling an operation of the transparence switching element based upon a light amount sensed by the optical sensor.

5. The electrical aperture and shutter device according to claim 1, wherein the transparence switching element is a liquid crystal panel.

6. The electrical aperture and shutter device according to claim 5, wherein the liquid crystal panel comprises a top glass substrate, a bottom glass substrate disposed opposite to the top glass substrate, and a liquid crystal layer interposed between the top glass substrate and the bottom glass substrate.

7. The electrical aperture and shutter device according to claim 6, wherein a transparent common electrode is formed on a surface of the top glass substrate which is adjacent to the liquid crystal layer.

8. The electrical aperture and shutter device according to claim 7, wherein a plurality of parallel scanning lines, a plurality of data lines substantially orthogonal to the parallel scanning lines and a plurality of pixel electrodes are formed on a surface of the bottom glass substrate which is adjacent to the liquid crystal layer.

9. The electrical aperture and shutter device according to claim 8, wherein the controller is configured for supplying a control signal to control an orientation of liquid crystal molecules in the liquid crystal layer, so as to carry out the functions of aperture and shutter.

10. The electrical aperture and shutter device according to claim 9, wherein different orientations of the liquid crystal molecules are carried out by an electric field.

11. A camera, comprising:
a lens;
an imaging device; and
an electrical aperture and shutter device having a transparent switch element, the electrical aperture and shutter device being configured for controlling an imaging light from the lens for imaging in the imaging device, wherein the electrical aperture and shutter device comprising:
an operating element configured for producing a signal;
a transparence switching element configured for controlling a transparence and a light-passing time of the transparence switching element and thereby carrying out the functions of aperture and shutter; and
a controller configured for controlling an operation of the transparence switching element by receiving the signal produced by the operating element.

12. The camera according to claim 11, wherein at time of the transparence switching element being operated to allow light to pass therethrough, the transparence switching element acts as an aperture and is configured for controlling an amount of passed light which is a total transparence of the transparence switching element.

13. The camera according to claim 11, wherein at time of the transparence switching element being operated to allow light to pass therethrough or not, the transparence acts a shutter and is configured for controlling a light-passing time at a certain transparence.

14. The camera according to claim 11, further comprising an optical sensor, the optical sensor being electrically connected with the controller, and the controller being configured for controlling an operation of the transparence switching element based upon a light amount sensed by the optical sensor.

15. The camera according to claim 11, wherein the transparence switching element is a liquid crystal panel.

16. The camera according to claim 15, wherein the controller is configured for supplying a control signal to control an orientation of liquid crystal molecules in the liquid crystal layer, so as to carry out the functions of aperture and shutter.

17. The camera according to claim 16, wherein different orientations of the liquid crystal molecules are carried out by an electric field.
